(19) United States
(12) Patent Application Publication
(10) Pub. No.: US 2005/0010724 A1
(43) Pub. Date: Jan. 13, 2005

(54) Method of controlling a cache memory, and corresponding cache memory device

(75) Inventor: Andrew Cofler, Voreppe (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics SA, Mountrouge (FR)

(21) Appl. No.: 10/874,804

(22) Filed: Jun. 23, 2004

(30) Foreign Application Priority Data
Jun. 25, 2003 (FR) 0307689

(51) Int. Cl. G06F 12/08

(52) U.S. Cl. 711/128; 711/145

(57) ABSTRACT

A cache memory is of the direct access type or of the set-associative type and includes NS sets each containing NW cache lines. NS is an integer greater than one, and NW is an integer equal to or greater than one. In the presence of a cache line access request, the content of the cache memory is scanned, the cache line is accessed if the latter is already allocated, and a new cache line is allocated in the cache memory in the contrary case. The cache memory is subdivided into SB subdivisions. Each subdivision includes NS/SB sub-sets each containing NW cache lines. Each subdivision is assigned a protection indication representative of whether or not the subdivision is protected. The scanning is carried out in all the subdivisions, whether protected or not. The access to a cache line already allocated is carried out even if that cache line belongs to a protected subdivision, whereas the allocation of a new cache line is carried out only in an unprotected subdivision.

### FIELD OF THE INVENTION

The invention relates to cache memories, and more particularly, to the management and control of their operation.

Background of the Invention

Cache memories are well known to those skilled in the art. In this respect the work of Hennessy and Patterson can be cited, “Computer Architecture: A Quantitative Approach”, chapter 5, second edition, Morgan Kaufmann Publishers Inc (San Francisco), ISBN 1-55860-329-8. A summary of some of the known features of a cache memory device will now be discussed below. Those skilled in the art may, for all practical purposes, refer to the abovementioned work for further details.

A cache memory device, which conventionally comprises a cache memory associated with a cache controller, is a high performance memory device used for storing data or instructions to which a central processor unit or processor must have frequent access. This is why a cache memory device is usually located immediately next to the processor. Consequently, a cache memory contains a portion of the memory, for example the program memory, containing the data or instructions necessary for the correct operation of the processor.

The working or allocation unit in a cache memory is the cache line. A cache line is used to contain a copy of the status of a memory block of the program memory or a data element. The number of data bytes associated with a cache line is the size of the cache line. A memory block is a continuous block of memory bytes and the size of a memory block equals the size of the cache line.

In a cache memory, a cache line is reproduced a certain number of times to form a group of cache lines. This group is usually called by those skilled in the art as a set. The variable used for selecting a cache line in a set is called a way, which is the term usually used by those skilled in the art. The number of ways in a set determines the size of the set and is an integer, equal to or greater than 1, and equal to a power of 2.

A set is then duplicated to form a cache memory. The variable used to select a set in the cache memory is called the index. The number of sets is an integer NS, equal to or greater than 1, and also a power of 2.

Usually, the address of a memory block determines in which set of the cache memory this memory block can be stored. The memory block can be stored in any one of the cache lines inside the selected set. The number of different cache lines in which a particular memory block can be stored defines the associativity of a cache memory, and is fixed by the number NW (NW is also the number of ways).

The associativity is a key parameter of a cache memory. Increasing the associativity allows greater flexibility in the allocation of memory blocks to the various cache lines. However, increasing associativity leads to cache memory implementations that are more costly and potentially slower in terms of access to the cache memory.

There are therefore three types of cache memory. If the number NW equals 1, it is a cache of the direct access type, also called “direct mapped cache”, a commonly used term. In this type of cache memory, a memory block can be stored in exactly one cache line of the cache memory.

If the numbers NW and NS are both strictly greater than 1, this is a cache of the “set-associative” type according to a commonly used term. In this type of cache memory, a memory block can be stored in any one of the NW cache lines of a given set of the cache memory.

If NW is strictly greater than 1 and if NS is equal to 1, this is a cache memory of the “fully associative” type according to a commonly used term. In this type of cache memory, a memory block may be stored in any one of the cache lines of the cache memory. The invention applies to cache memories of the direct access type or of the set-associative type.

When the microprocessor has to access a data element or an instruction, the usual procedure is to scan the content of the cache memory to see if it is there. If the data element is present in the cache memory, this is a success (a hit as it is commonly called) and the data element is read rapidly in the cache (if the access operation is a read access) or written rapidly in the cache memory if the access operation is a write access (overwriting an existing data element).

If the data element is absent from the cache memory, this is a failure (a miss as it is commonly called) and the data element is read in random access memory and is then copied into the cache memory for a later access. More precisely, in the event of a miss, then the allocation of a cache line is determined. In a set-associative cache with N ways, this means choosing one way among the N ways.

If one of the ways is not already occupied, that way will be chosen. If, on the other hand, the N ways are already occupied, one of them will be chosen with a view to its replacement. This way may be chosen by using several possible algorithms. The most frequently used algorithm is the one known to those skilled in the art as the least recently used (LRU).

Two events may occur depending on whether the cache line to be replaced is clean (i.e., an exact copy of the content corresponding to the main memory) or dirty (i.e., has a content more up to date than the corresponding content in the main memory).

The clean/dirty status of a cache line is determined for example by a specific bit associated with each cache line. In the presence of a clean status, the new cache line may simply overwrite the old cache line in the cache memory. In the presence of a dirty status, before the new cache line can replace the old cache line, the latter must be evicted to the main memory (i.e., the main memory is updated with the content of the cache line to ensure consistency).

The final step includes extracting the instruction or the data element from the main memory, writing it in the allocated cache line, and designating that cache line as valid. It should be noted here that the step of checking or scanning the content of the cache memory is carried out at the time of each cache memory access request, whether it is a read or write access. But the procedure mentioned above may not be the same for a read or write miss. So, for example, sometimes caches may allocate new cache lines only in a read mode whereas in a write mode the data element is simply written into the main memory without allocating any new cache line in the cache memory.

The processors that cooperate with cache memories for the interchange of data or instructions can create difficulties with real time systems because the operation of the cache may be extremely non-deterministic. Now, tasks that have severe real time constraints cannot accept non-deterministic behaviors because that may cause malfunctions of the application.

The main problem is the one known as interference. Interference may be intrinsic (thrashing, according to the term usually used, between processes in a given task) or extrinsic (thrashing between different tasks).

Thrashing is the phenomenon by which cache lines are continually allocated and then replaced/evicted from the cache memory. The thrashing phenomenon can be disastrous for the overall performance of the cache memory device, and is particularly dangerous when real time behaviors are required.

This is the case for example in mobile telephony applications in which certain tasks are less important (e.g., re-running audio data) whereas other tasks are real time tasks (e.g., modem communication operations). This thrashing phenomenon may be yet more inconvenient in a mechanical control environment, for example in the control of hard disks where, if the real time constraints are not observed, the mechanical system may break down.

Intrinsic interference may be avoided by making cache memories as associative as possible. As for extrinsic interference, to ensure that a real time data element or instruction is effectively in the cache memory at the moment when the processor must use that data element or instruction, there are two approaches which use the fact that the cache memory is formed of a body of cache lines and, when the cache exhibits associativity by way, a body of ways.

A first approach includes locking the cache memory by cache line. Thus, a cache line that is locked cannot be replaced. And, if a real time data element or instruction is present in such a locked cache line, this guarantees its presence in the cache memory every time this data element is accessed by the processor.

Such a locking by the cache line has the advantage of offering very fine granularity, i.e., a cache line granularity, but has the disadvantage of having to know the address exactly. This is not always very easy or possible at the management level by the software controlling the processes or the tasks (e.g., the real time operating system RTOS).

Another approach, applicable in set-associative (or fully associative) caches, includes using a lock by cache way. In such cases, it is a complete way that is locked, which prevents any data element or instruction situated in such a locked way from being replaced.

Such an approach offers a coarser granularity than cache line granularity but can be used to lock a predetermined portion of the cache memory without being attached to specific addresses. Such an approach, however, has two major disadvantages:

A first disadvantage is as follows. If each task requires a cache memory having a certain level of associativity, the complete cache memory must have a very high level of associativity, for example a 16-way associative cache. Such caches are very difficult to design, particularly when it involves the added provision of high frequencies of operation and/or a low consumption.

A second disadvantage is as follows. A specific mechanism must be used to force the storage of data or instructions in the way in question before it is locked. But, by the very nature of set-associative cache memories, a data element can be placed in any of the ways of a set, the chosen way being determined by a replacement algorithm which is often based on the access history (for example a Least Recently Used LRU) algorithm in which the least recently used data element is replaced. As a consequence, this requires a series of specific manipulations to force the storage of a data element in a particular way before it is locked, as for example, described in the document “Analog Devices ADSP-21535”, Blackfin DSP Hardware Reference; Revision 1.0, October 2002, pages 6-25.

### SUMMARY OF THE INVENTION

In view of the foregoing background, an object of the invention is to provide a locking of the cache memory which does not require precise knowledge of the addresses of cache lines to be locked, and which is a definite advantage over the locking by the cache line approach. Another object of the invention is to provide a locking of the cache which simplifies production.

The cache memory is divided into subdivisions, with each subdivision having the same associativity as the complete cache memory, but simply with a smaller size. This distinguishes the invention from the “lock by way” approach. Furthermore, there is no complex software procedure for ensuring that the data is placed in the required location, contrary to what happens in the Analog Device Blackfin component mentioned above.

A method for controlling a cache memory of the direct access type or of the set-associative type comprising NS sets each containing NW cache lines is provided. NS is an integer greater than 1, and NW is an integer equal to or greater than 1. The method comprises in the presence of a cache line access request, a scan of the content of the cache memory, an access to the cache line if the latter is already allocated, and an allocation in the cache memory of a new cache line if the latter is not already allocated.

According to a general feature of the invention, the cache memory may be subdivided into SB subdivisions, each subdivision comprising NS/SB sub-sets each containing NW cache lines. Each subdivision may be assigned a protection indication representative of whether or not the subdivision is protected. This protection indication may come, for example, from a memory management unit.

The scanning step may be carried out in all the subdivisions, whether protected or not. The access to a cache line already allocated may be carried out even if that cache line belongs to a protected subdivision, whereas the allocation of a new cache line is carried out only in an unprotected subdivision. In other terms, according to the invention, the cache memory may be subdivided horizontally, that is, by sections perpendicular to the ways.

Furthermore, all the subdivisions may always be accessed, whether or not they are protected, in order to determine the conditions of success or failure (hit or miss) after scanning. This maintains consistency and avoids cache aliasing when subdivisions are protected/unprotected for various tasks, since the content of the complete cache memory is always visible for all the tasks irrespective of the fact that the subdivisions are protected or not.

Furthermore, authorizing access to a cache line that is already allocated, even if that cache line belongs to a protected subdivision, means, during a write access, that a task currently being executed by the processor is not prevented from modifying a data element that is already present in the cache memory.

According to an embodiment of the invention in which the cache memory comprises a data storage zone and an address storage zone, the request to access a cache line is carried out using an address word comprising an index and a tag. Furthermore, each cache line in the data storage zone may be associated with an address field of the address storage zone. This address field may be intended to contain an extended tag of an address word. This extended tag may be formed of the tag of an address word as well as a predetermined number of high order bits of the index, depending on the number of subdivisions.

The number of subdivisions may run from 2 to theoretically NS, in powers of 2. The number of subdivisions may be limited by the production constraints and this number may be 4 or 8, for example. The predetermined number of high order bits of the index equals log₂ (number of subdivisions).

Each subdivision of the address storage zone may comprise NS/SB sub-zones individually addressable by an abbreviated index of an address word. This abbreviated index may be formed of bits of the index of an address word except for the predetermined number of high order bits of that index. Furthermore, each sub-zone may contain NW address fields, with each address field being capable of containing an extended tag.

In the scanning step, the content of each of the NW address fields of each sub-zone designated by the abbreviated index of the address word associated with the access request may be compared with the extended tag of this address word, and a scanning information element representative of the success or failure of this scan is delivered.

An information element representative of the success of the scan may advantageously comprise a first digital word representative of the subdivision comprising the address field containing the extended tag of the address word associated with the access request, and the data storage zone is thus addressed on the basis of the first digital word and the abbreviated index of the address word associated with the access request.

In the case of a set-associative cache memory, that is, in which NW is greater than 1, an information element representative of the success of the scan advantageously may comprise a second digital word representative of the position of the address field in the sub-zone designated by the abbreviated index of the address word. The cache line belonging to the NW cache lines designated by the first digital word may then be selected, using the second digital word.

In the presence of an information element representative of a failure of the scan, an assignment digital word designating an unprotected subdivision of the cache memory may be generated and the new cache line may be allocated in the subdivision thus designated, and in the sub-group of this subdivision designated by the abbreviated index of the address word associated with the access request. For example, the assignment digital word can be generated on the basis of the predetermined number of high order bits of the index and the subdivision protection indications.

Another aspect of the invention is directed to a cache memory device comprising a cache memory of the direct access type or of the set-associative type comprising NS sets each containing NW cache lines, with NS being an integer greater than one and NW being an integer equal to or greater than one, A cache controller, in the presence of a cache line access request, activates scanning the content of the cache memory for authorizing an access to the cache line if the latter is already allocated, and for allocating in the cache memory a new cache line in the contrary case (which may lead for example to the eviction of an old cache line).

According to a general feature of the invention, the cache memory may be subdivided into SB subdivisions, with each subdivision comprising NS/SB sub-sets each containing NW cache lines. Each subdivision may be assigned a protection indication representative of whether or not the subdivision is protected. The means of scanning are suitable for carrying out the scan in all the subdivisions, whether protected or not. The cache controller allows the access to a cache line already allocated even if that cache line belongs to a protected subdivision, whereas the cache controller allocates a new cache line only in an unprotected subdivision.

According to an embodiment of the invention, in which the cache memory comprises a data storage zone and an address storage zone, the cache line access request may comprise an address word comprising an index and a tag. Each cache line of the data storage zone may be associated with an address field of the address storage zone. This address field may contain an extended tag of an address word. This extended tag may be formed of the tag of an address word as well as a predetermined number of high order bits of the index depending on the number of subdivisions.

Each subdivision of the address storage zone may comprise NS/SB sub-zones individually addressable by an abbreviated index of an address word. This abbreviated index may be formed of the bits of the index of an address word except for the predetermined number of high order bits of this index. Each sub-zone may contain NW address fields, with each address field for containing an extended tag.

The scanning means may comprise comparison means for comparing the content of each of the NW address fields of each sub-zone designated by the abbreviated index of the address word associated with the access request, with the extended tag of this address word, and deliver a scanning information element representative of the success or failure of this scan.

An information element representative of the success of the scan may comprise a first digital word representative of the subdivision comprising the address field containing the extended tag of the address word associated with the access request. The data storage zone may be addressable on the basis of the first digital word and the abbreviated index of the address word associated with the access request.

When NW is greater than one, an information element representative of the success of the scan may comprise a second digital word representative of the position of the address field in the sub-zone designated by the abbreviated index of the address word. The cache memory may comprise selection means for selecting the cache line belonging to the NW cache lines designated by the first digital word by using the second digital word.

The cache controller may comprise generation means, suitable, in the presence of an information element representative of a scan failure, for generating an assignment digital word designating an unprotected subdivision of the cache memory. The new cache line may be allocated in the subdivision thus designated and in the sub-set of this subdivision designated by the abbreviated index of the address word associated with the access request. The generation means may generate the assignment digital word on the basis of the predetermined number of high order bits of the index and the indications of protection of the subdivisions.

### BRIEF DESCRIPTION OF THE DRAWINGS

Other advantages and features of the invention will appear on examination of the detailed description of the embodiments and applications, that are in no way limiting, and of the appended drawings in which:

FIG. 1 illustrates schematically a cache memory device according to the invention;

FIG. 2 illustrates in greater detail but still schematically the internal architecture of a cache memory belonging to a cache memory device according to the invention;

FIG. 3 illustrates an embodiment of a method according to the invention; and

FIGS. 4 and 5 illustrate schematically an example of generating an assignment digital word designating an unprotected subdivision.

### DETAILED DESCRIPTION OF THE PREFERRED EMBODIMENTS

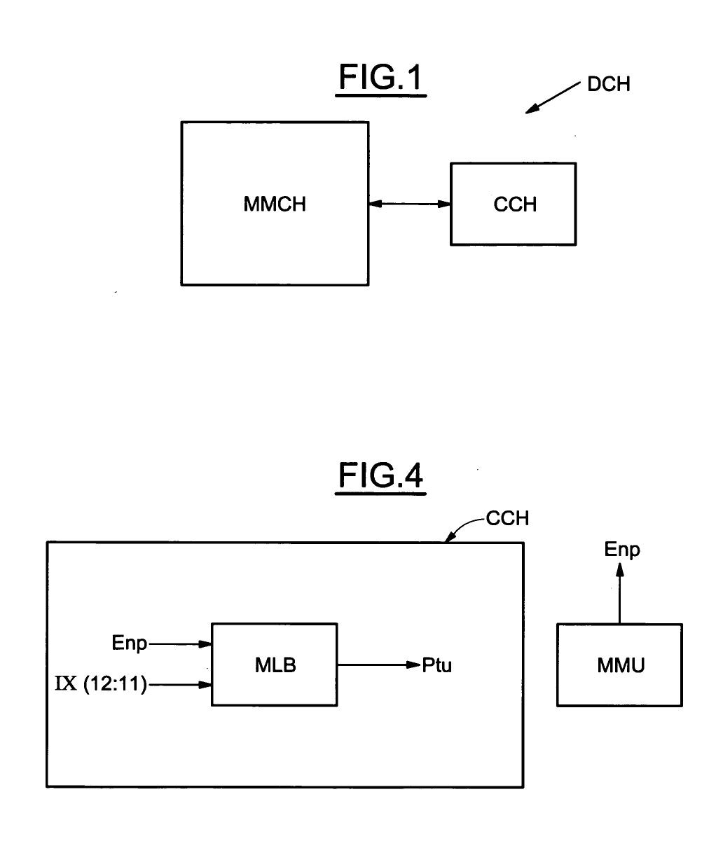

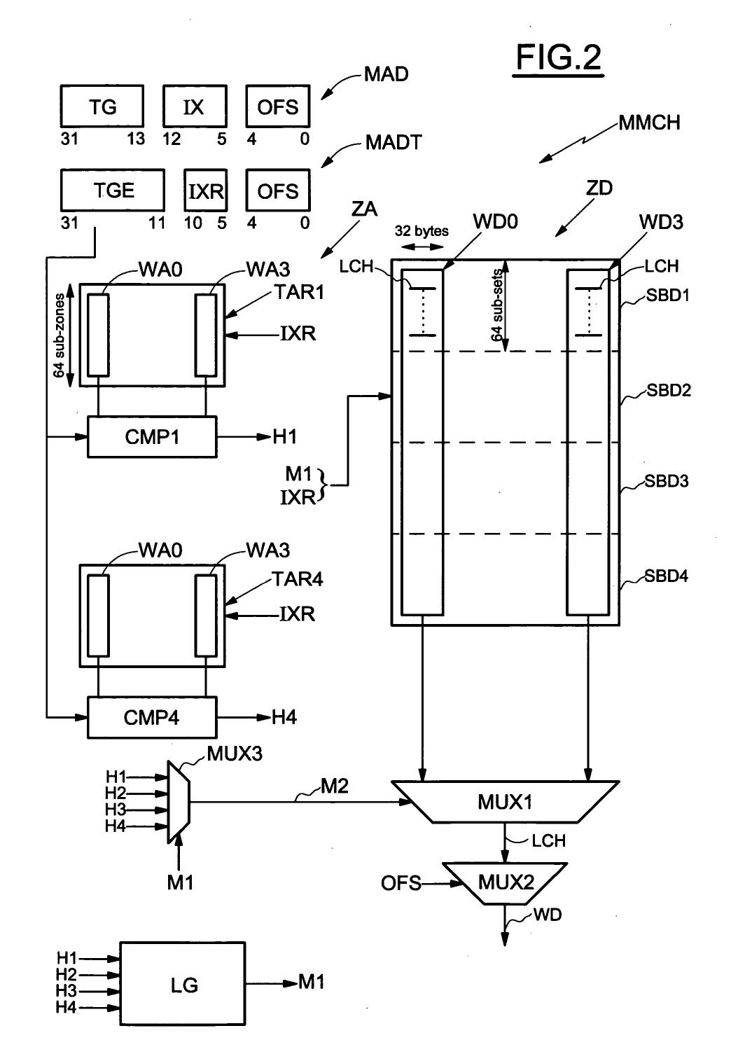

In FIG. 1, the reference DCH designates a cache memory device according to the invention comprising an actual cache memory MMCH associated with a cache controller CCH. The cache memory device, which will now be described as a non-limiting example by referring more particularly to FIG. 2, is a device of the set-associative type having a total cache size of 32 kilobytes. The cache memory MMCH comprises NS=256 sets of cache lines. Each set comprises NW=4 ways. In other terms, each set comprises NW cache lines LCH each having a size of 32 bytes.

This cache memory device works in a 32-bit address space. The cache parameters used here correspond for example to a level 1 cache in a current processor. This being so, the invention applies to any type of cache device, irrespective of its size, whether it is of the set-associative type (irrespective of the level of set-associativity) such as the one described now, or of the direct access type. Furthermore, the invention also applies whether the cache is physical or virtual, that is, whether it relates to physical or virtual addresses.

The invention is also independent of the behavior of the cache device itself, that is, the method of updating the random access or program memory (not depicted in the figures). Thus, the invention applies whether this embodiment is of the “write through” type according to the term normally used by those skilled in the art, in which the new data are updated in the memory and in which therefore no data exist only in the cache memory, or of the “write back” type in which the line is copied into memory only in certain cases.

The invention also applies irrespective of the mode of allocation in the cache memory and irrespective of the mode of allocation of the ways. The invention further applies irrespective of the physical implementation of the cache memory.

In FIG. 2, the cache memory MMCH comprises an address storage zone ZA and a data storage zone ZD. Within the meaning of the present invention, the words data element are understood here as capable of being an actual data element or an instruction for example.

In general, the cache memory is subdivided into SB subdivisions, here into four subdivisions. Thus, the data zone ZD comprises four subdivisions SBD1-SBD4. Each subdivision comprises 64 sub-sets each containing four cache lines LCH (level of associativity equals 4). Likewise, the address storage zone comprises four subdivisions TAR1-TAR4. Each subdivision TARi comprises 64 sub-zones. Each sub-zone is intended, as will be seen in greater detail below, to be able to store four extended tags TGE of address words MAD.

In the data storage zone ZD, the ways are referenced WD0-WD3 while in the address storage zone ZA, the ways are referenced WA0-WA3. Whether it is a write or read request, the request to access a cache line LCH is carried out using an address word MAD comprising an index IX, a tag TG, a supplementary portion, currently designated the “offset” OFS. In the example described here, in which the address space is on 32 bits, bits 0 to 4 of the address words form the offset OFS whereas bits 5 to 12 form the index and bits 13 to 31 form the tag TG.

The number of bits of the tag, the index and the offset is directly linked to the cache parameters (size, size of the cache line, level of associativity). On the basis of the address word MAD, a transformed address word MADT is formed still comprising the offset portion OFS. However, the index is now transformed into an abbreviated index IXR formed uniquely of bits 5 to 10 while the tag is transformed into an extended tag TGE formed of bits 11 to 31. This involves an offset of two bits corresponding to log₂(4), with 4 being the number of subdivisions.

It has been shown that each subdivision TARi of the address storage zone ZA was formed of 64 sub-zones, each comprising four positions intended to contain four extended tags TGE. Each sub-zone is individually addressable by the abbreviated index IXR of the address word.

At the foot of each subdivision TARi are situated means of comparison CMPi intended, as will be shown in greater detail below, to compare an extended tag TGE of an address word MAD with the content of the four address fields of a sub-zone of the subdivision in question. This sub-zone is selected by the abbreviated index IXR.

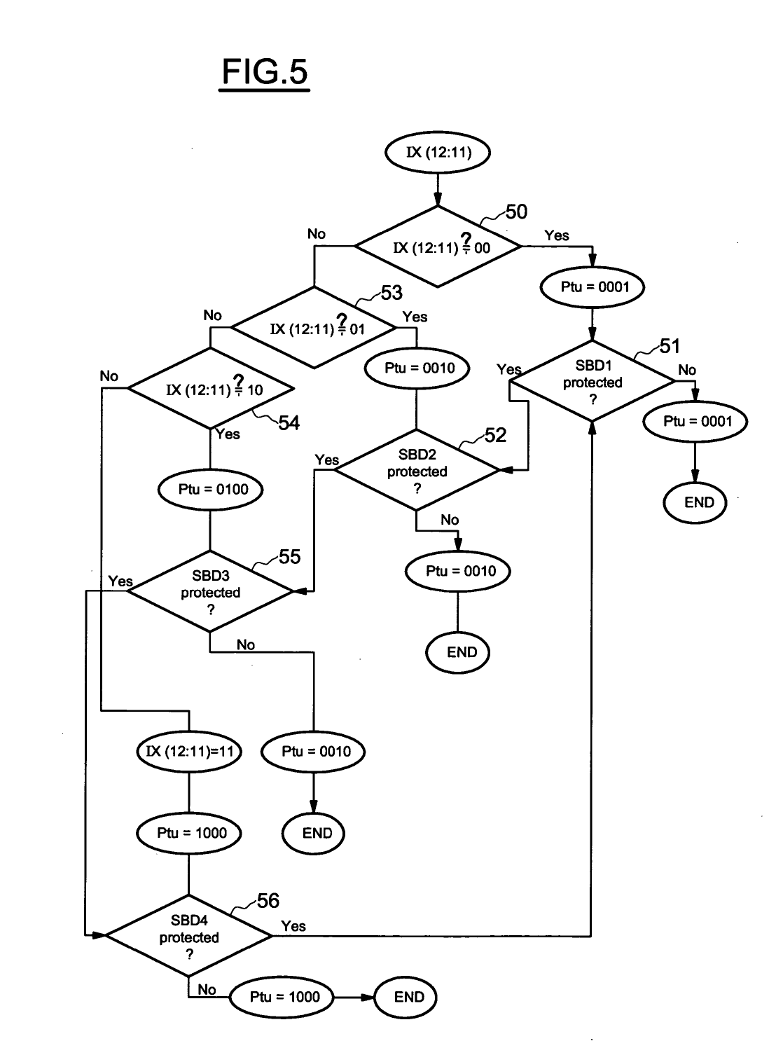

In general, each of the subdivisions is allotted a protection indication, formed for example of a four-bit word Enp (since there are four subdivisions here) delivered for example by a memory management unit MMU (FIG. 4). The word Enp indicates, for each subdivision, whether it is protected or not. And, according to the invention, a new cache line can be allocated only in an unprotected subdivision.

To preserve complete consistency between the data contained in the cache memory subdivided according to the invention MMCH, the following diagram is used. The first phase of access to the cache memory in the presence of an access request, in read or write mode, is a scanning phase to determine whether the cache line designated by this access request is or is not already present in the cache memory.

This scan is carried out in all the subdivisions of the cache memory, whether they are protected or not. This in particular means that all read access requests “see” the complete content of the cache memory. In this scanning step, the extended tag TGE of the transformed address word MADT associated with the access request is delivered to the four comparison means CMP1-CMP4. Furthermore, in each of the subdivisions TARi, four address fields respectively contained in ways WAO and WA3 are selected by the abbreviated index IXR of the transformed address word.

If the cache line which is the subject of the request is already present, that is, already allocated in the cache, its extended tag is situated, by the very construction of the cache memory, in a single address field of the cache memory. If each comparison means CMPi delivers a comparison word Hi of four bits, respectively associated with four ways WAO-WA3, it will be supposed here that one bit Hi [j]=0 means that the comparison between the extended tag TGE of the transformed address word MATD and the address field of the way in question WAi was negative. That is, the corresponding address field did not comprise the extended tag TGE. In the contrary case, the bit of the comparison word is at 1.

In the event that the scanning step is successful, there will exist by construction a single comparison word Hi having a single bit at 1. All the other bits of this comparison word and all the other bits of the other comparison words will be at 0. From here on, logic means LG, receiving the four comparison words H1-H4 deliver a first digital word M1 representative of the subdivision TARi comprising the address field containing the extended tag of the address word associated with the access request.

The data storage zone ZD will then be addressed on the basis of the first digital word M1 and the abbreviated index IXR of the address word associated with the access request. This will enable selection in the data storage zone ZD of the subdivision SBDi corresponding to the subdivision TARi having led to the success of the scan, and, within this subdivision SBDi, the body of the four cache lines LCH designated by the abbreviated index IXR.

During a read access, which is more particularly illustrated in FIG. 2, the contents of the four cache lines LCH thus designated in the data storage zone ZD are delivered at the output of the four ways WD0-WD4 to the four inputs of a multiplexer MUX1. This multiplexer MUX1 is controlled by a second digital word M2 which is representative of the position of the address field having led to the success of the scan, that is, the way that leads to the hit.

In practice, this word M2 is one of the comparison words H1-H4 which are delivered at the input of a multiplexer MUX3 controlled by the first digital word M1. Consequently, at the output of the multiplexer MUX1, the cache line LCH having been the subject of the read access request is obtained.

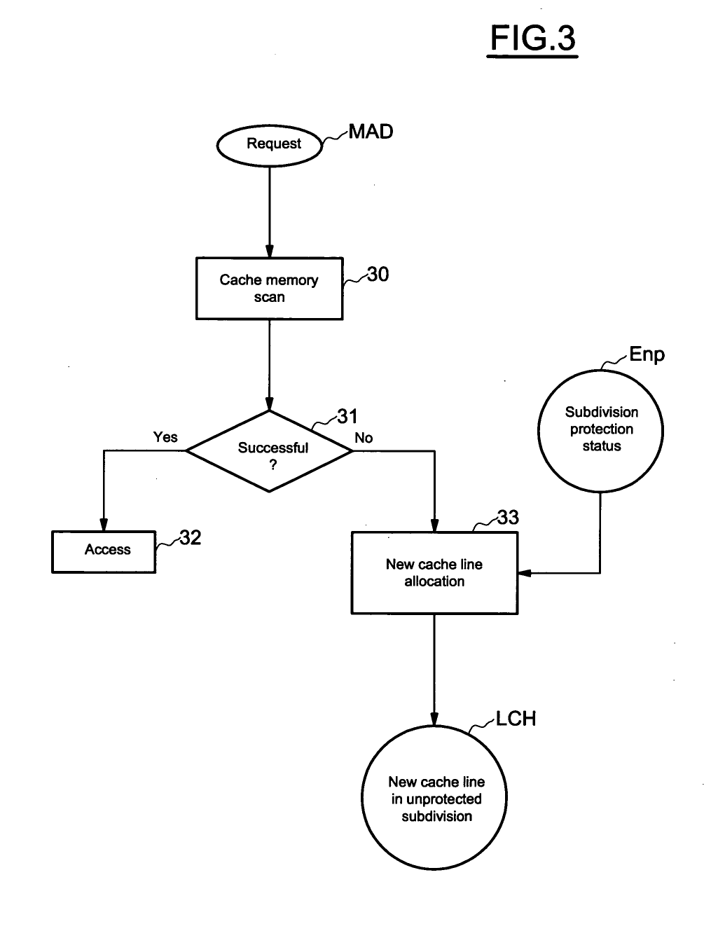

The particular data word of this cache line designated by the address word MAD is then selected by means of the offset OFS controlling a multiplexer MUX2. The output of the multiplexer MUX2 delivers the word WD required and designated by the address word MAD. So it can be seen that in the event of success after the scanning phase (steps 30 and 31, FIG. 3), the access 32 to a cache line is carried out as in the case of a conventional cache memory device.

However, in the event of a scanning failure, that is, if all the comparisons CMPi are negative, a new cache line must then be allocated (step 33) in the cache memory. According to the invention, this can be carried out only in an unprotected subdivision. The choice of this subdivision, made for example by the cache controller CCH, then takes account of the subdivision protection status Enp.

Thus, according to the invention, a data element stored in a protected subdivision is itself protected, that is, it cannot be evicted from the cache memory. Similarly, the unused storage space, that is, the invalid cache lines, within the protected subdivisions, are themselves protected since a new allocation cannot use that space.

There are several techniques of choosing the subdivision to be used in the event of failure following a scanning step. The method used depends on the application and the method of production of the cache memory. A non-limiting example will now be given.

As depicted in FIG. 4, the cache controller CCH comprises generation means MLB suitable for generating, on the basis of the digital word Enp and the two high order bits of the index IX, a digital word Ptu designating the subdivision to be used.

As an example, this word Ptu is a word of four bits in which the bit that takes the value 1 designates an unprotected subdivision. When the four subdivisions are unprotected, that is, all available for a possible new allocation, a correspondence can be established between the two high order bits of the index and the four bits of the word Ptu.

More particularly, if the two high order bits of the index equal “00”, then the word Ptu equals 0001 designating subdivision No. 1. If the two high order bits of the index equal “01”, then the word Ptu equals 0010 designating subdivision No. 2.

Similarly, if the two high order bits of the index equal “10”, then the word Ptu equals 0100 designating subdivision No. 3. Finally, if the two high order bits of the index equal “11”, then the word Ptu equals 1000 designating subdivision No. 4.

If on the other hand, at least one of the subdivisions is protected, then the word Enp representative of the subdivision protection status and the two high order bits of the index of the address word associated with the access request are combined in the generation means to determine the assignment word Ptu.

As an example, suppose in FIG. 5 that the cache memory comprises only one protected subdivision. Thus, if in step 50 the two high order bits of the index IX are equal to 00, then the assignment word Ptu is a priori equal to 0001.

Then, there is a check to see if the subdivision SBD1 designated by this word Ptu is protected or not (step 51). If the subdivision SBD1 is not protected, then the word Ptu is enabled at the value 001. If, however, the subdivision SDB1 is protected, then the subdivision SBD2 will be checked to see whether or not it is protected.

As in the present case, it was supposed that a single subdivision was protected, but the subdivision SDB2 is not protected. Consequently, the value 0010 will be assigned to the word Ptu and the new allocation of the cache line will be carried out in this subdivision.

The same process applies if the high order bits of the index equal 01, 10 or 11 (steps 53, 54, 55, 56). In hardware terms, the generation means MLB can be easily designed by circuits and logic gates based on the algorithm illustrated in FIG. 5, using for example a logic synthesis algorithm.

There are of course trivial cases. So for example, if a single subdivision is available, that is, if all the others are protected, then this subdivision will be used irrespective of the value of the two high order bits of the index.

1-16. (Cancelled).

17. A method for controlling a cache memory comprising NS sets each containing NW cache lines, with NS being an integer greater than one and NW being an integer equal to or greater than one, the method comprising:
dividing the cache memory into SB subdivisions, each subdivision comprising NS/SB sub-sets each containing NW cache lines;
assigning each subdivision a protection indication representative of whether or not the subdivision is protected;
scanning all the subdivisions whether or not the subdivision is protected in the presence of a cache line access request; and
accessing a cache line if the cache line has already been allocated, even if the cache line belongs to a protected subdivision, and if the cache line has not already been allocated, then allocating a new cache line from an unprotected subdivision.

18. A method according to claim 17, wherein the cache memory comprises a data storage zone and an address storage zone, and the cache line access request comprising an address word comprising an index and a tag, and each cache line in the data storage zone is associated with an address field of the address storage zone, this address field for containing an extended tag of an address word, the extended tag being formed of the tag of an address word as well as a predetermined number of high order bits of an index depending on the number of subdivisions.

19. A method according to claim 18, wherein each subdivision of the address storage zone comprises NS/SB sub-zones individually addressable by an abbreviated index of an address word, the abbreviated index being formed of bits of the index of an address word except for the predetermined number of high order bits of that index, each sub-zone containing NW address fields, with each address field for containing an extended tag.

20. A method according to claim 19, wherein in the scanning, a content of each of the NW address fields of each sub-zone designated by the abbreviated index of the address word associated with the access request is compared with the extended tag of this address word, and a scanning information element representative of the success or failure of this scan is delivered.

21. A method according to claim 20, wherein an information element representative of a success of the scan comprises a first digital word representative of the subdivision comprising the address field containing the extended tag of the address word associated with the access request, in that the data storage zone is addressed on the basis of the first digital word and the abbreviated index of the address word associated with the access request.

22. A method according to claim 21, wherein for a cache memory in which NW is greater than one, wherein an information element representative of the success of the scan comprises a second digital word representative of the position of the address field in the sub-zone designated by the abbreviated index of the address word, and wherein the cache line belonging to the NW cache lines designated by the first digital word is selected using the second digital word.

23. A method according to claim 22, wherein in the presence of an information element representative of a failure of the scan, an assignment digital word designating an unprotected subdivision of the cache memory is generated and the new cache line is allocated in the subdivision thus designated, and the sub-group of this subdivision designated by the abbreviated index of the address word is associated with the access request.

24. A method according to claim 23, wherein the assignment digital word is generated on the basis of the predetermined number of high order bits of the index and the subdivision protection indications.

25. A cache memory device comprising:
a cache memory comprising NS sets each containing NW cache lines, with NS being an integer greater than one and NW being an integer equal to or greater than one, each subdivision being assigned a protection indication representative of whether or not the subdivision is protected, said cache memory also comprising a scanner for scanning the subdivisions; and
a cache controller coupled to said cache memory, and in the presence of a cache line access request, said cache controller for activating said scanner;
said scanner for performing the following when activated
scanning all the subdivisions whether or not the subdivision is protected in the presence of the cache line access request, and
accessing a cache line if the cache line has already been allocated, even if the cache line belongs to a protected subdivision, and if the cache line has not already been allocated, then allocating a new cache line from an unprotected subdivision.

26. A cache memory device according to claim 25, wherein said cache memory comprises a data storage zone and an address storage zone, wherein the cache line access request comprises an address word comprising an index and a tag, and each cache line in the data storage zone is associated with an address field of the address storage zone, this address field for containing an extended tag of an address word, the extended tag being formed of the tag of an address word as well as a predetermined number of high order bits of the index depending on the number of subdivisions.

27. A cache memory device according to claim 26, wherein each subdivision of the address storage zone comprises NS/SB sub-zones individually addressable by an abbreviated index of an address word, the abbreviated index being formed of bits of the index of an address word except for the predetermined number of high order bits of that index, each sub-zone containing NW address fields, with each address field for containing an extended tag.

28. A cache memory device according to claim 27, wherein said scanner comprises a comparator and a content of each of the NW address fields of each sub-zone designated by the abbreviated index of the address word associated with the access request is compared with the extended tag of this address word, and a scanning information element representative of the success or failure of this scan is delivered.

29. A cache memory device according to claim 28, wherein an information element representative of a success of the scan comprises a first digital word representative of the subdivision comprising the address field containing the extended tag of the address word associated with the access request, in that the data storage zone is addressed on the basis of the first digital word and the abbreviated index of the address word associated with the access request.

30. A cache memory device according to claim 29, wherein NW is greater than one, and an information element representative of the success of the scan comprises a second digital word representative of the position of the address field in the sub-zone designated by the abbreviated index of the address word, and wherein said cache memory comprises a selector for selecting the cache line belonging to the NW cache lines designated by the first digital word using the second digital word.

31. A cache memory device according to claim 30, wherein said cache controller comprises a generation circuit and in the presence of an information element representative of a scan failure, generates an assignment digital word designating an unprotected subdivision of said cache memory and the new cache line is allocated in the subdivision designated, and the sub-set of this subdivision designated by the abbreviated index of the address word is associated with the access request.

32. A cache memory device according to claim 31, wherein said generation circuit generates the assignment digital word on the basis of the predetermined number of high order bits of the index and the subdivision protection indications.

33. A cache memory device comprising:
a cache memory comprising NS sets each containing NW cache lines, with NS being an integer greater than one and NW being an integer equal to or greater than one, each subdivision being assigned a protection indication representative of whether or not the subdivision is protected; and
a cache controller coupled to said cache memory for activation of a scanning of the subdivisions in the presence of a cache line access request;
said cache memory for performing the following in response to said cache controller
scanning all the subdivisions whether or not the subdivision is protected in the presence of the cache line access request, and
accessing a cache line if the cache line has already been allocated, even if the cache line belongs to a protected subdivision, and if the cache line has not already been allocated, then allocating a new cache line from an unprotected subdivision.

34. A cache memory device according to claim 33, wherein said cache memory comprises a data storage zone and an address storage zone, wherein the cache line access request comprises an address word comprising an index and a tag, and each cache line in the data storage zone is associated with an address field of the address storage zone, this address field for containing an extended tag of an address word, the extended tag being formed of the tag of an address word as well as a predetermined number of high order bits of the index depending on the number of subdivisions.

35. A cache memory device according to claim 34, wherein each subdivision of the address storage zone comprises NS/SB sub-zones individually addressable by an abbreviated index of an address word, the abbreviated index being formed of bits of the index of an address word except for the predetermined number of high order bits of that index, each sub-zone containing NW address fields, with each address field for containing an extended tag.

36. A cache memory device according to claim 35, wherein said cache memory comprises a comparator and a content of each of the NW address fields of each sub-zone designated by the abbreviated index of the address word associated with the access request is compared with the extended tag of this address word, and a scanning information element representative of the success or failure of this scan is delivered.

37. A cache memory device according to claim 36, wherein an information element representative of a success of the scan comprises a first digital word representative of the subdivision comprising the address field containing the extended tag of the address word associated with the access request, in that the data storage zone is addressed on the basis of the first digital word and the abbreviated index of the address word associated with the access request.

38. A cache memory device according to claim 37, wherein NW is greater than one, and an information element representative of the success of the scan comprises a second digital word representative of the position of the address field in the sub-zone designated by the abbreviated index of the address word, and wherein said cache memory comprises a selector for selecting the cache line belonging to the NW cache lines designated by the first digital word using the second digital word.

39. A cache memory device according to claim 38, wherein said cache controller comprises a generation circuit and in the presence of an information element representative of a scan failure, generates an assignment digital word designating an unprotected subdivision of said cache memory and the new cache line is allocated in the subdivision designated, and the sub-set of this subdivision designated by the abbreviated index of the address word is associated with the access request.

40. A cache memory device according to claim 36, wherein said generation circuit generates the assignment digital word on the basis of the predetermined number of high order bits of the index and the subdivision protection indications.

41. A cache memory device according to claim 33, wherein said cache memory is of the direct access type or of the set-associative type.
